(19) United States
(12) Patent Application Publication
(10) Pub. No.: US 2015/0347415 A1
(43) Pub. Date: Dec. 3, 2015

(54) HTTP LIVE STREAMING DATERANGES

(71) Applicant: Apple Inc., Cupertino, CA (US)

(72) Inventors: Roger N. Pantos, Cupertino, CA (US); Eryk Vershen, San Francisco, CA (US); William B. May, JR., Sunnyvale, CA (US)

(21) Appl. No.: 14/503,165

(22) Filed: Sep. 30, 2014

Related U.S. Application Data
(60) Provisional application No. 62/005,267, filed on May 30, 2014.

(51) Int. Cl. G06F 17/30; H04L 29/06

(52) U.S. Cl. CPC G06F 17/30053; G06F 17/30598; G06F 17/30029; H04L 65/4069

(57) ABSTRACT

Systems and methods use a new syntax defining a daterange tag that allows an author of a media stream to embed an arbitrary set of defined ranges in the media stream associated playlist. The defined ranges may be used to provide an overview of or otherwise define the playlist and media stream structure. When a playlist is updated and the timing window of the playlist advances, any daterange tags in the playlist that map to any defined range or media segment in the updated playlist will persist in the updated playlist. Any daterange tags in the playlist that map to defined ranges that have completed will be dropped from the updated playlist.

### CROSS-REFERENCE TO RELATED APPLICATIONS

The present application claims priority to U.S. Provisional Application No. 62/005,267 filed May 30, 2014, the entirety of which is incorporated by reference herein.

### BACKGROUND

The present invention relates to transmission of media and in particular to the organization of data transmitted in a media stream.

Video distribution systems conventionally include a video source and at least one receiving device to receive video content. The video content may be distributed over a network, such as broadcast television, Over The Top (OTT) delivery, Internet Protocol Television (IPTV), etc., or over fixed media, such as Blu-ray, DVDs, etc. Currently, network-based media delivery services are available that support delivery of coded video for a plurality of media types including real time media feeds, such as live media. Those media delivery services typically code an input video sequence, called a “media stream” herein, as coded video data that has been parsed into a plurality of separately deliverable segments. Each segment may represent a portion of the source media stream, for example, a five or ten second increment of the media stream. The media delivery service may include a server that responds to requests from other devices on the network, called a “client” herein, and furnishes the coded segments in response to those requests. The requests typically identify requested segments by an address, such as a uniform resource locator (commonly, “URL”). A common server may respond to service requests from a number of different client devices contemporaneously.

Video data distributed via a media delivery service often includes data identifying the media segments in the transmitted media stream. For example, in an HTTP Live Streaming (HLS) media stream, a text file known as a playlist, that identifies each video segment in the media stream and includes metadata for the video data, is transmitted with the stream.

However, the data received via the playlist is limited to known types of data identified by predefined tags in the playlist such that receiving devices receive only a limited amount of information about the contents of the data stream. Therefore, there is a need in the art for an improved syntax that allows video and audio data stream authors to provide additional structural information that describes the video segments of the data stream.

### BRIEF DESCRIPTION OF THE DRAWINGS

The foregoing and other aspects of various embodiments of the present invention will be apparent through examination of the following detailed description thereof, in conjunction with the accompanying drawing figures in which similar reference numbers are used to indicate functionally similar elements.

FIG. 1 is a functional block diagram of an exemplary streaming system according to an embodiment of the present invention.

FIG. 2 illustrates an exemplary coding architecture for a video stream according to an embodiment of the present invention.

FIG. 3 illustrates an exemplary subset of a playlist that includes a daterange tag according to an embodiment of the present invention.

FIG. 4 illustrates an exemplary subset of a playlist that includes a set of daterange tags according to an embodiment of the present invention.

FIG. 5 illustrates an exemplary method for updating a playlist according to an embodiment of the present invention.

### DETAILED DESCRIPTION

According to an embodiment, a syntax is defined that allows an author of a media stream to embed a description of an arbitrary set of defined ranges in the playlist. The defined ranges may be used to provide an overview of the playlist structure, for example, program and chapter boundaries, ad and ad-pod boundaries, or program highlights. When a playlist is updated and the timing window of the playlist advances, any daterange tags in the playlist that maps to any defined range or media segment in the updated playlist will persist in the updated playlist. Any daterange tags in the playlist that map to defined ranges that have completed will be excluded from the updated playlist.

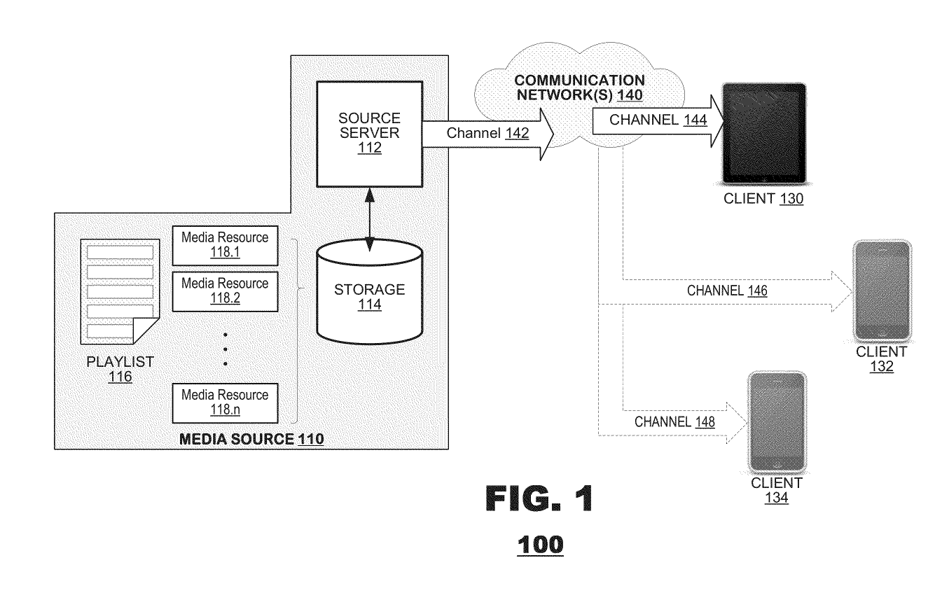

FIG. 1 is a functional block diagram of an exemplary streaming system 100 according to an embodiment of the present invention. The system may include a media source 110 and one or more client devices 130, 132, 134 interconnected via a communication network 140.

The media source 110 may include a source server 112 that performs processing operations on behalf of the media source 110 and a storage system 114 that stores the playlist 116 and coded segments of the available media resources 118.1-118.n.

During operation, a media source 110 may receive and code an input media stream as a plurality of coded segments 118.1-118.n and may generate a playlist 116 to identify segments that are accessible by the server 112 of the media source 110. Upon a request from a receiving device 130, the media source 110 may transmit the coded segments 118.1-118.n to entities on the communication network 140 via one or more channels 142, 144, 146, 148. For streaming applications involving live video, the media source 110 may store coded video segments for a predetermined amount of time (for example, 5 mins. of source video) and thus, older segments may be evicted from storage 114 as new segments are generated and stored. Similarly, the playlist 116 may be updated over time to reflect generation of new segments and eviction of older segments. According to an embodiment, some of these operations may be performed by the source server 112 including coding of a source media stream into segments 118.1-118.n of coded video data, and development and maintenance of a playlist 116 identifying storage locations of the segments 118.1-118.n.

The client device(s) 130, 132, 134 represent exemplary media players that request and download coded segments from the media source 110, and decode the coded segments and render them for playback. The client 130 may additionally download a playlist 116 from the media source 110. The client 130 may then select a coded segment (say, segment 118.3) for delivery and decoding. If the media source 110 stores the requested segment 118.3, it may furnish the segment 118.3 to the client 130 for decoding and rendering. Thereafter, the client 130 may advance to the next entry in the playlist 116 and direct another request to the server 112.

The client 130 may refresh its copy of the playlist 116 from time to time and continue with the processes described above by downloading coded segments from the media source 110. This operation may continue until the client 130 discontinues playing the media stream.

According to an embodiment, the architecture presented in FIG. 1 may be expanded to accommodate multiple instances of media sources 110 and clients 130-134. For example, a single media source 110 may code and transmit multiple media streams to multiple clients 130-134, or a single media source 110 may code and transmit a common media stream in a variety of different bit rates or a variety of different frame sizes to accommodate capabilities of different types of clients where each coded variant of a media stream may be considered to be a different coded media sequence for purposes of the present discussion.

According to an embodiment, the media source 110 and client devices 130 may communicate with each other via a common network 140 such as the Internet or may be connected via separate networks (not shown). For example, via a gateway device or router (not shown) connected to the client 130 by a wired or wireless local area network. The gateway device may then be connected to the media source 110 via a wide area network. Therefore the distribution, topology and architecture of the communication network(s) 140 is immaterial to the operation of the present invention unless discussed otherwise herein.

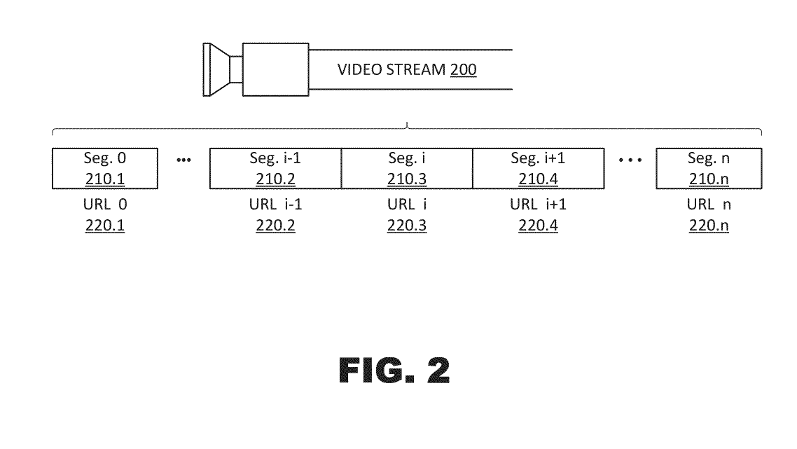

FIG. 2 illustrates an exemplary coding architecture for a video stream 200 according to an embodiment of the present invention. Although the video stream 200 is shown as originating from a camera, the stream 200 may be provided to the media streaming system 100 from another source, for example, from a media feed (such as a satellite feed or production feed) or from a storage device. A video stream 200 may be represented as a sequence of individual source frames that may be coded according to one or more compression algorithms, which typically yield a sequence of compressed frames that have a reduced data rate as compared to the source frames. The coded video sequence may then be parsed into a plurality of coded segments 210.1-210.n that may be stored by the media source 110 at potentially discrete locations from each other. For example, each segment may be stored by the media source 110 at locations that can be referenced by unique uniform resource locators 220.1-220.n (commonly, “URLs”).

Each segment will be associated with a program date and time. However, if a segment does not include date and time information, the date and time for a segment may be extrapolated from a segment that has an associated program date-time tag. The date and time associated with the segments of a media stream will be mapped so that each segment in the stream has an unambiguous and precise start date and time. Thus the boundaries of each segment will be known (or can be extrapolated) and will be precise dates/times.

A playlist may identify the available media streams and the locations of each segment as stored at the media source. The playlist may contain a fixed length of media data as a sliding window. For example, the playlist may include information for a two-hour sliding window of video data. Then, once time has passed, the playlist may include information on data from the media stream that has already been played. The playlist will be periodically updated or refreshed and the oldest information will be dropped as the time window advances.

The playlist may include a plurality of tags that provide information to the client regarding the content of the media stream. A daterange tag included in the playlist may provide details of the playlist or media stream structure.

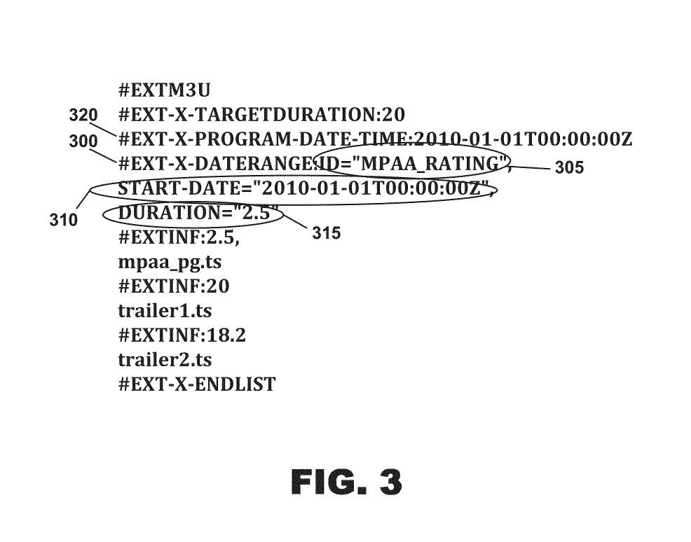

FIG. 3 illustrates an exemplary subset of a playlist that includes a daterange tag 300 according to an embodiment of the present invention. As shown in FIG. 3, the daterange syntax may be used by a media stream author to associate metadata with a time and date in the media stream. For example, daterange tags may be used to identify individual programs, chapters, ads, program highlights, etc. Although the daterange tag 300 is shown as wrapping around to a second and a third line in FIG. 3 for ease of display, the entire daterange tag 300 is considered a single line of the playlist.

A daterange tag may include certain predefined attributes that describe the defined range. Predefined attributes may include an ID that uniquely identifies a defined range in the playlist 305, a start date which describes the precise date (including the precise time) at which the defined range begins 310, an optional duration of the defined range in seconds 315, and an optional class which describes a user-defined grouping (not shown). Certain attributes may be considered mandatory for any defined range (e.g. ID and start date) while other attributes may be considered optional (e.g. duration and class). As shown in FIG. 3, the defined range has an ID of “MPAA_RATING”, a start date of Jan. 1, 2010 at time 00:00:00.000, and a duration of 2.5 seconds.

To operate correctly, a playlist should not have any daterange tags with the same ID value. However, if a playlist contains two daterange tags with the same ID value, then the tag attributes should also be identical—e.g. any attribute that appears in multiple daterange tags must have the same value in each daterange tag. However, as described more fully below, one exception is that otherwise identical daterange tags may have different duration attributes.

The precise start date of a defined range may be represented by an ISO-8601 date string that includes the combined date and time. Thus, the start date is not defined relative to any data in the media stream and does not rely on the playback time. However, the start date of a defined range must be on the same timeline as the program date that applies to the media segments in the range. As shown in FIG. 3, a program date-time tag 320 should be included in the playlist in order to extrapolate timing for the segments listed in the playlist.

The duration is a positive number that indicates the length of the range defined by the daterange tag. The duration should reflect the actual duration of the defined range, not just the planned duration. If a duration is not present for a daterange tag, the duration of the defined range is unknown. A single instant in time may be represented with a duration attribute of 0.

A daterange tag may additionally include user-defined attributes. A user-defined attribute may use a reverse-DNS syntax to avoid collisions. Additionally, the name of the user-defined attribute will follow a predefined syntax for an attribute name as described more fully below. The user-defined attribute may be limited to certain data types, for example, a string or decimal floating point.

An exemplary user defined attribute is shown below:
X-COM-EXAMPLE-AD-ID=“XYZ123”

In this example, the name of the user defined attribute is “X-COM-EXAMPLE-AD-ID” and the value for the AD-ID attribute of the daterange tag is “XYZ123.” Therefore, in this example, the user has defined an attribute to associate an ad identifier with the daterange tag. A class may specify the set of attributes applied to the defined range. Daterange tags with the same class attribute value should have similar user-defined attributes.

Using the daterange tags to gain an understanding of the structure of the media file, the media stream author may set or define playback policies that will be implemented by the client device. For example, a playback policy may require that certain ad segments be played before the subsequent media segments can be played. Additionally, the defined ranges provide metadata descriptive of a portion of the media stream, for example, the program name, type, or other useful information. Knowledge of the media stream file may also aid in decoding and playback adjustments. For example, certain segments may be decoded and/or displayed at a lower quality than other segments in the media steam.

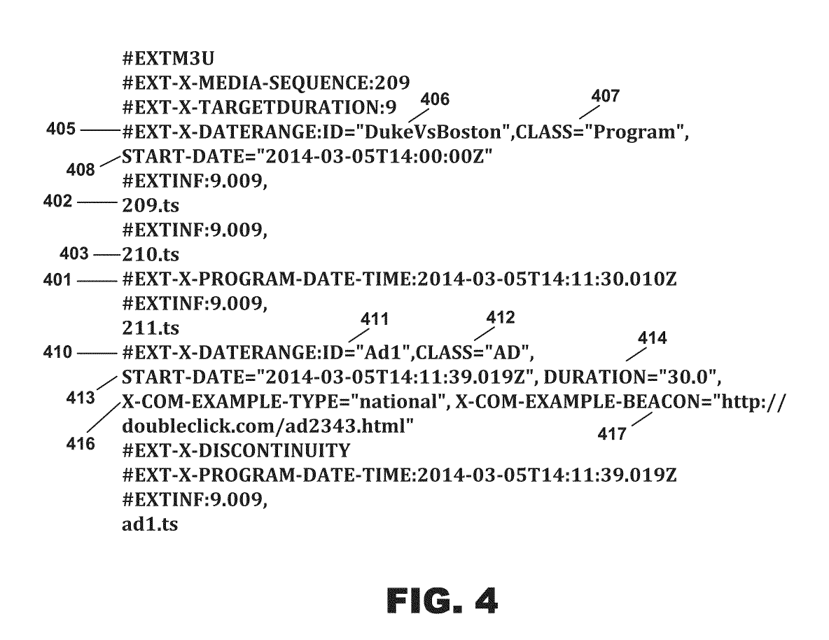

FIG. 4 illustrates an exemplary subset of a playlist that includes a set of daterange tags according to an embodiment of the present invention. The playlist shown in FIG. 4 illustrates a four segment (36 second) window for a program that started at 14:00:00. During that window, the start of an ad interrupts the main program flow.

When the playlist is updated, the updated window should include at least one program date-time tag. In FIG. 4, the program date-time tag 401 is for 14:11:30.01. As previously noted, the date-time of the other segments in the window may be extrapolated from the program date-time tag 401. In the example shown in FIG. 4, because segments 209.ts 402 and 210.ts 403 are each of 9 seconds and 9 milliseconds duration, that means that the first segment in the playlist is played at 14:11:11.982 (program date-time tag 401 minus 9.009 seconds for segment 210.ts 403 and minus 9.009 seconds for segment 209.ts 402).

As shown in FIG. 4, a first range is defined by the first daterange tag 405 with an ID of “DukeVsBoston” 406 of the class “Program” 407 and with a start date of Mar. 15, 2014 at time 14:00:00 408. The first defined range shown in FIG. 4, DukeVsBoston, is an open-ended defined range because it does not include a duration. To close an opened defined range, a subsequent daterange tag having all the same attribute values of the original daterange tag (e.g. daterange tag 405) but with the duration set to a known value will be inserted into the playlist. When the newly set duration has completed, the defined range will then be considered closed. According to an embodiment, the subsequent daterange tag may consist solely of the daterange ID and the updated duration attributes.

A second range is defined by the second daterange tag 410 with an ID of “Ad1” 411 of class type “AD” 412 with a start date of Mar. 5, 2014 at time 14:11:39.019 413 and a duration of 30 seconds 414. The AD1 daterange tag 410 additionally includes user-defined attributes: a type attribute 416 with a value of “national” and a beacon attribute 417 with a value of “http://doubleclick.com/ad2343.html.” The AD1 range defined by the second daterange tag 410 is a closed defined range as it includes a duration. Therefore the AD1 defined range will expire 30 seconds after the AD1 defined range began. However, as shown in FIG. 4, this boundary will be outside the 36 second window of the media segments defined in the playlist and therefore will be outside the current limits of the playlist.

According to an embodiment, a closed defined range may receive an updated duration if a subsequent daterange tag having all the same attribute values of the original daterange tag but with a new duration value will be inserted into the playlist.

According to an embodiment, a defined range may have a start time or an end time outside the current playlist limits. When the playlist is refreshed to drop information regarding old media already played and outside the traditional playlist window, the daterange tags initiating any open defined ranges or initiating any closed defined ranges that have not yet completed will persist until the duration of the defined range has completed. Therefore the daterange tags will “stick” to the top of the playlist until all the segments within the defined range roll off the playlist.

According to an embodiment, if a playlist that is used to represent multiple different versions of the same media (e.g. a Master Playlist) contains multiple Media Playlists, for example, each Media Playlist may describe a different available version of the same content, then each Media Playlist will contain the same set of defined ranges as the Master Playlist. Each defined range in the Media Playlists will be identified by the same ID attribute value and contain the same set of attributes and attribute values. However, the daterange tags need not be used in the Master Playlist itself.

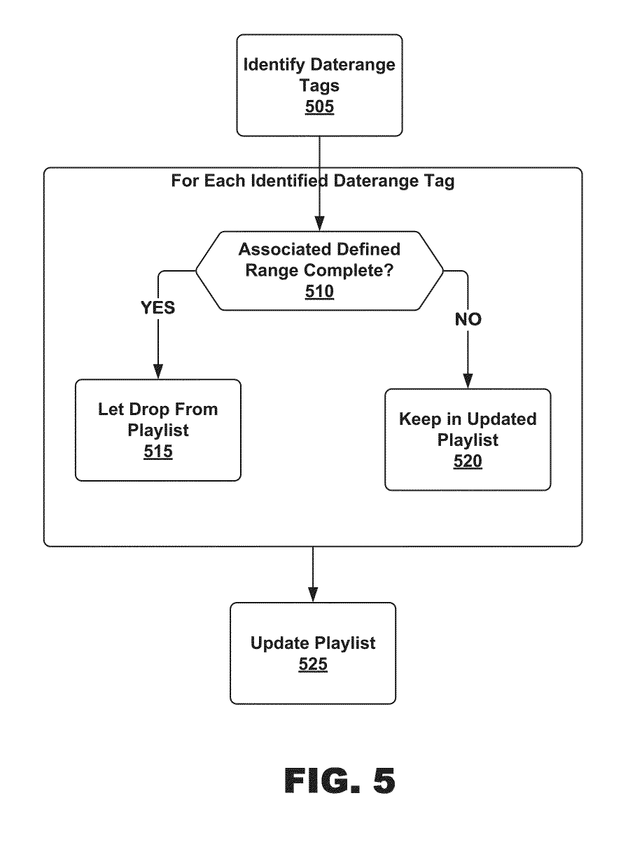

FIG. 5 illustrates an exemplary method for updating a playlist according to an embodiment of the present invention. As shown in FIG. 5, to update or refresh a playlist, the media source may first identify any daterange tags in the expired playlist (block 505). As previously noted, the playlist may be updated periodically to refresh the media stream data presented in the playlist. For example, the playlist may be refreshed at a specific time interval, as the system and network resources allow, or when a certain percentage of the segments described in the playlist have already been played.

Then, once one or more daterange tags have been identified, for each identified daterange tag, the media source will determine if range defined by the daterange tag has been completed (block 510). As previously noted, a defined range will be considered completed when the defined range is closed, e.g. it has a fixed duration, and the duration of the defined range has already been played. An open defined range may be also completed by the insertion of a subsequent daterange tag having the same daterange ID and a duration of zero where the subsequent daterange tag has also already been played (e.g. the media stream playback has passed the insertion point of the subsequent daterange tag).

If the defined range associated with the identified daterange tag has been completed, the daterange tag will be dropped from the playlist (block 515). However, if the defined range associated with the identified daterange tag has not been completed or is open, the daterange tag will persist in the playlist, at least until the next update (block 520). Once all the daterange tags have been identified and evaluated, the playlist can be updated (block 525). The updated playlist may then be transmitted to one or more devices that are receiving the media stream.

According to an embodiment, SCTE-35 compliant signal information in a media stream may be represented in a playlist as a defined range. Each SCTE-35 splice event, timestamp signal, or private command will be represented by a separate defined range. The ID of the defined range may include the splice_event_id and/or the segmentation_event_id. However, if the splice_event_id or segmentation_event_id are not unique in the playlist, the value of the ID must be altered to make identification of each defined range unambiguous. The PTS corrected SCTE-35 program time of the relevant slice will be the start date for the defined range.

The duration of the defined range will be the actual duration of the splice if known. If the actual duration of the splice is not known, the duration attribute of the daterange tag will not have a value and the defined range will be open ended. If the actual duration is subsequently discovered, a daterange tag with the same ID and having the duration attribute value set may be added to the playlist. The subsequent daterange tag will update the parameters of the defined range. Similarly, to cancel a splice after an associated daterange tag has already been added to the playlist, another daterange tag having the same ID with the duration attribute set to zero will be added to the playlist.

The planned duration of the splice may be represented as a user-defined planned duration attribute of the daterange tag. The daterange tag may carry other various SCTE-35 commands as user-defined attributes such that the attribute value is the big-endian representation of the command expressed as a hexadecimal integer. For example, a splice_insert( )command can be represented by an S35-SPLICE attribute, the time_signalQ command can be represented by an S35-TIME attribute, and the private_cmd( )command can be represented by an S35-PRIV attribute.

If the SCTE-35 commands have a non-empty descriptor loop, the daterange tag will have an S35-DESC attribute with the packed array of splice_descriptor( )as the attribute value. If the source media uses pairs of segmentation_descriptorQ commands to bracket the SCTE-35 content segments, the ending segmentation_descriptorQ command may be represented as an S35-END-DESC attribute in the daterange. If the S35-END-DESC attribute is not known at the time the daterange tag is created, as previously noted the defined range may be updated by including the S35-END-DESC information in a second daterange tag having the same ID as the first. In that instance, the second daterange tag should also include the duration attribute set to the actual duration of the content segment thereby updating the duration of the defined range with the newly discovered duration.

Although primarily described with reference to date-time tags defined using ISO-8601 date/times, embodiments may use a relative time based on the playback of the media stream. Additionally, although primarily described considering live media streaming, embodiments may be used with video on demand and other playback and video streaming methods.

As discussed above, FIG. 1 illustrates functional block diagrams of exemplary systems according to an embodiment of the present invention. In implementation, the systems may be embodied as hardware, in which case, the illustrated blocks may correspond to circuit sub-systems within the systems. Alternatively, the components of the systems may be embodied as software, in which case, the blocks illustrated may correspond to program modules within software programs. In yet another embodiment, the systems may be hybrid systems involving both hardware circuit systems and software programs.

In other instances, well-known operations, components and circuits have not been described in detail so as not to obscure the embodiments. It can be appreciated that the specific structural and functional details disclosed herein may be representative and do not necessarily limit the scope of the embodiments.

Moreover, not all of the functional blocks described herein need be provided or need be provided as separate units. Such implementation details are immaterial to the operation of the present invention unless otherwise noted above. Additionally, although FIG. 5 illustrates an exemplary method, the order of operations may be altered or some operations skipped entirely.

Some embodiments may be implemented, using a non-transitory computer-readable storage medium or article which may store an instruction or a set of instructions that, if executed by a processor, may cause the processor to perform a method in accordance with the disclosed embodiments. The exemplary methods and computer program instructions may be embodied on a non-transitory machine-readable storage medium. In addition, a server or database server may include machine-readable media configured to store machine executable program instructions. The features of the embodiments of the present invention may be implemented in hardware, software, firmware, or a combination thereof and utilized in systems, subsystems, components or subcomponents thereof. The machine-readable storage media may include any medium that can store information. Examples of a machine-readable storage medium include electronic circuits, semiconductor memory device, ROM, flash memory, erasable ROM (EROM), floppy diskette, CD-ROM, optical disk, hard disk, fiber optic medium, or any electromagnetic or optical storage device.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method for updating a media stream playlist, the method comprising:
identifying at least one description defining a range in an expired playlist;
for each identified description:
if an updated playlist contains media associated with the defined range, including the description in the updated playlist;
if the updated playlist does not contain media associated with the defined range, excluding the description from the updated playlist; and
updating the playlist.

2. The method of claim 1, wherein the at least one description is a daterange tag.

3. The method of claim 1, wherein a closed defined range has a duration attribute in an associated description and the closed defined range has completed when the duration has passed and the updated playlist does not contain media associated with the defined range.

4. The method of claim 1, wherein an open defined range has been completed when a description associated with the defined range has been updated to define a duration, the defined duration has passed, and the updated playlist does not contain media associated with the defined range.

5. A method for determining the structure of a media stream, the method comprising,
identifying at least one daterange tag defining a range in a playlist received with the media stream;
for each identified daterange tag, identifying a defined range, wherein the defined range includes at least one media segment of the media stream, said identifying a defined range including determining whether the defined is open or closed.

6. The method of claim 5, further comprising, identifying a completed defined range.

7. The method of claim 6, wherein a closed defined range has a duration attribute in an associated daterange tag, and the closed defined range has completed when the duration has passed and the updated playlist does not contain media associated with the defined range.

8. The method of claim 6, wherein an open defined range has been completed when a daterange tag associated with the defined range has been updated to define a duration, the defined duration has passed, and the updated playlist does not contain media associated with the defined range.

9. The method of claim 5, further comprising, identifying an open defined range as a daterange having an associated daterange tag without a defined duration attribute.

10. The method of claim 5, further comprising, identifying a closed defined range as a defined range having an associated daterange tag with a defined duration attribute.

11. The method of claim 5, further comprising, for an identified daterange tag having a user-defined attribute, using the user-defined attribute to further define the associated defined range.

12. The method of claim 5, wherein said identifying a defined range further comprises determining a precise start time of the defined range with the media stream based on a start time attribute of the associated daterange tag.

13. A media distribution system comprising:
a memory for storing media data and a playlist describing the media data;
a server to receive requests for the media data and to update the playlist associated with the media data, the server configured to:
identify at least one description defining a range in an expired playlist;
for each identified description:
if an updated playlist contains media associated with the defined range, include the description in the updated playlist;
if the updated playlist does not contain media associated with the defined range, drop the description from the updated playlist; and
transmit an updated playlist.

14. The system of claim 13, wherein the at least one description is a daterange tag.

15. The system of claim 13, wherein a closed defined range has a duration attribute in an associated description and the closed defined range has completed when the duration has passed and the updated playlist does not contain media associated with the defined range.

16. The system of claim 13, wherein an open defined range has been completed when a description associated with the defined range has been updated to define a duration, the defined duration has passed, and the updated playlist does not contain media associated with the defined range.

17. A system comprising:
a memory for storing a media stream playlist;
a processor configured to determine a structure of a received media stream by:
identifying at least one daterange tag defining a range in the media stream playlist;
for each identified daterange tag, identifying a defined range, wherein the defined range includes at least one media segment of the media stream, said identifying a defined range including determining whether the defined range is open or closed.

18. The system of claim 17, wherein the processor is further configured to identify a completed defined range.

19. The system of claim 18, wherein a closed defined range has a duration attribute in an associated daterange tag, and the closed defined range has completed when the duration has passed and the updated playlist does not contain media associated with the defined range.

20. The system of claim 18, wherein an open defined range has been completed when a daterange tag associated with the defined range has been updated to define a duration, the defined duration has passed, and the updated playlist does not contain media associated with the defined range.

21. The system of claim 17, wherein the processor is further configured to identify an open defined range as a defined range having an associated daterange tag without a defined duration attribute.

22. The system of claim 17, wherein the processor is further configured to identify a closed defined range as a defined range having an associated daterange tag with a defined duration attribute.

23. The system of claim 17, wherein for an identified daterange tag having a user-defined attribute, the processor is further configured to utilize the user-defined attribute to further define the associated defined range.

24. The system of claim 17, wherein at least one identified daterange tag describes an SCTE-35 event, signal, or command.
